(19) United States
(12) Patent Application Publication
(10) Pub. No.: US 2009/0079725 A1
(43) Pub. Date: Mar. 26, 2009

(54) DISPLAY DEVICE AND METHOD FOR DRIVING THE SAME

(75) Inventors: Nobuyoshi Saito, Kawasaki-Shi (JP); Tomomasa Ueda, Yokohama-Shi (JP); Yujiro Hara, Yokohama-Shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 12/210,516

(22) Filed: Sep. 15, 2008

(30) Foreign Application Priority Data
Sep. 25, 2007 (JP) 2007-247978

(51) Int. Cl. G06F 3/038

(52) U.S. Cl. 345/213

(57) ABSTRACT

A display device includes: a drive circuit supplying a first signal voltage and a first reverse bias in a first frame time period, and supplying a second signal voltage and a second reverse bias in a second frame time period subsequent to the first frame time period; a first drive TFT receiving the first signal voltage to supply a first drive current based on the first signal voltage in the first frame time period, and receiving the second reverse bias in the second frame time period; a second drive TFT receiving the first reverse bias in the first frame time period, and receiving the second signal voltage to supply a second drive current based on the second signal voltage in the second frame time period; and a display element emitting light based on the first drive current in the first frame time period and emitting light based on the second drive current in the second frame time period.

### CROSS-REFERENCE TO RELATED APPLICATION

This application is based upon and claims the benefit of priority from prior Japanese Patent Application No. 2007-247978 filed on Sep. 25, 2007 in Japan, the entire contents of which are introduced herein by reference.

### BACKGROUND OF THE INVENTION

1. Field of the Invention

The present invention relates to a display device and its drive method.

2. Related Art

In recent years, an organic electroluminescence (EL) display device using an OLED (organic light emitting diode) which is a self-activated luminescence element is drawing attention as the plane type display device, and study thereof is being conducted vigorously. In the organic EL display device, an organic EL element is a self-activated luminescence element. As compared with a liquid crystal display device in which strength of transmitted light from back light is controlled by a pixel circuit including a liquid crystal cell, the organic EL display device has features such as nonnecessity of back light, a wide viewing angle of images, and suitability to moving picture reproduction due to fast responsibility.

In the organic EL display device, a simple (passive) matrix scheme and an active matrix scheme can be adopted as its drive scheme in the same way as the liquid crystal display device. However, whereas the display device of the simple matrix scheme is simple in structure, there is a problem that implementation of a large-sized high definition display device is difficult. In recent years, therefore, development of a display device of active matrix scheme in which a current flowing through the electroluminescent element is controlled by an active element such as a thin film transistor (hereafter referred to as TFT as well) provided in the same pixel circuit as the electroluminescent element has been conducted vigorously.

In the display device of the active matrix scheme, each pixel includes an OLED serving as a display element and a pixel circuit which supplies a drive current to the display element. In the organic EL display device, display operation is conducted by controlling luminous luminance of the display element. The pixel circuit includes, for example, a drive transistor (hereafter referred to as “drive TFT” as well) connected to the display element in series, a switch transistor (hereafter referred to as “switch TFT” as well) connected between a data line and a gate of the drive TFT, and a capacitor connected between the gate of the drive transistor and its source to retain a voltage according to a video signal.

Unlike the liquid crystal cell, the OLED is a current drive type self-activated luminescence element. Therefore, it is necessary for the drive TFT connected to the display element in series to be always in the ON state and let flow a current. As time elapses, therefore, characteristic degradation such as mobility lowering and a rise in threshold voltage Vth becomes observed in the drive TFT. Typically, such characteristic degradation of the TFT changes the current value at the time of operation and is recognized as luminance unevenness or sticking of each pixel at the time of operation of the organic EL display device. Above all, a TFT formed of silicon having a low crystallization property such as amorphous silicon is very large in the extent of the threshold voltage shift, resulting in great hindrance to putting it to practical use.

It is attempted to form a compensation circuit in the pixel circuit to compensate the threshold voltage shift of a TFT formed of amorphous silicon every pixel. According to this technique, it is contrived to store the threshold voltage of the drive TFT as a voltage across a retaining capacitance by providing a threshold voltage compensation time period in addition to write time and luminous time and conducting diode connection on the drive TFT to connect the drive TFT to power supply lines.

However, the compensation circuit does not essentially reduce the threshold voltage shift value. When the threshold voltage shift gradually increases, the compensation range is exceeded soon and the display quality of the display device abruptly falls.

On the other hand, methods of suppressing the threshold voltage shift itself of the TFT formed of amorphous silicon by contriving a drive method are proposed. One of them is the reverse bias applying scheme. For example, according to J. H. Lee et al., p.165, SID 07 Digest, a threshold voltage shift in the positive direction caused by applying a positive bias during a luminous time period is canceled by applying a bias which is opposite in polarity to that at the gate ON time, i.e., a negative bias between the source and gate of the drive FFT formed of amorphous silicon.

In the reverse bias applying scheme, the threshold voltage shift value can be reduced by contriving the drive method as described above. In the reverse bias applying scheme, therefore, favorable display quality can be sustained over a long time period. Since it is necessary to provide a reverse bias applying time in addition to the luminous time period, however, the ratio of the luminous time period in one frame (duty factor) decreases, and consequently the luminance also falls. For example, according to J. H. Lee et al., p.165, SID 07 Digest, the duty factor falls to approximately 50%.

### SUMMARY OF THE INVENTION

The present invention has been made in view of these circumstances, and an object thereof is to provide a display device capable of suppressing the threshold voltage shift while sustaining a high duty factor, and its drive method.

According to a first aspect of the present invention, there is provided a display device including a drive circuit which supplies a first signal voltage and a first reverse bias in a first frame time period, and supplies a second signal voltage and a second reverse bias in a second frame time period subsequent to the first frame time period; a first drive TFT which receives the first signal voltage to supply a first drive current based on the first signal voltage in the first frame time period, and receives the second reverse bias in the second frame time period; a second drive TFT which receives the first reverse bias in the first frame time period, and receives the second signal voltage to supply a second drive current based on the second signal voltage in the second frame time period; and a display element which emits light based on the first drive current in the first frame time period and emits light based on the second drive current in the second frame time period.

According to a second aspect of the present invention, there is provided a method for driving a display device including a display element, and first and second drive TFTs which supply a drive current based on a signal voltage to the display element, the drive method including, in a first frame time period, supplying the drive current to the display element by applying the signal voltage based on the drive current for the display element to the first drive TFT and applying a reverse bias to the second drive TFT, and in a second frame time period subsequent to the first frame time period, supplying the drive current to the display element by applying the signal voltage to the second drive TFT and applying the reverse bias to the first drive TFT.

### BRIEF DESCRIPTION OF THE DRAWINGS

FIG. 1 is a circuit diagram of a display device according to a first embodiment of the present invention;

FIG. 2 is a diagram showing drive waveforms of the display device according to the first embodiment;

FIG. 3 is an equivalent circuit diagram of a pixel in a display device according to a second embodiment; and

FIG. 4 is a diagram showing drive waveforms of the display device according to the second embodiment.

### DETAILED DESCRIPTION OF THE INVENTION

Hereafter, embodiments of the present invention will be described with reference to the drawings.

### First Embodiment

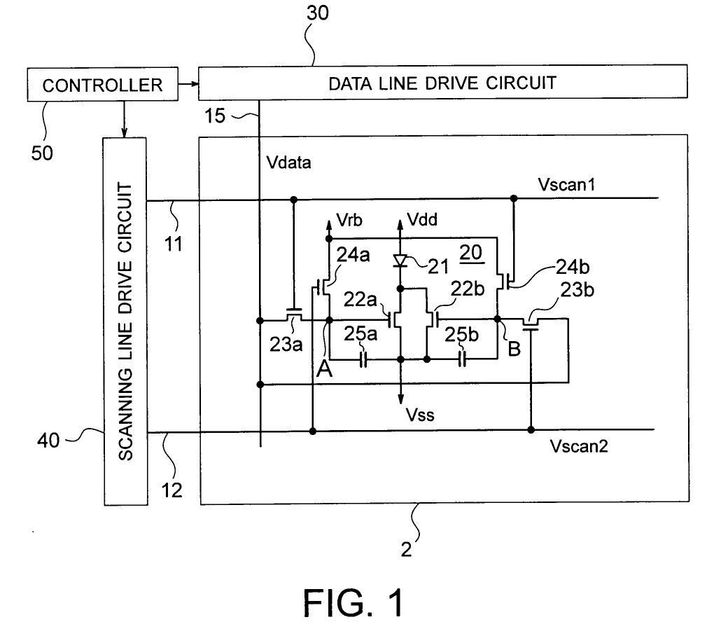

A circuit diagram of a display device according to a first embodiment of the present invention is shown in FIG. 1. The display device according to the present embodiment is an active matrix type display device. The display device according to the present embodiment includes a pixel array part 2, a data line drive circuit 30, a scanning line drive circuit 40, and a controller 50 which synchronizes the drive circuits 30 and 40.

The pixel array part 2 includes a plurality of pixels 20 arranged in a matrix form. In FIG. 1, only one pixel 20 is shown. Each pixel 20 includes a display element 21, two drive TFTs 22a and 22b, two signal switch TFTs 23a and 23b, two reverse bias switch TFTs 24a and 24b, and two capacitors 25a and 25b.

Two scanning lines 11 and 12 are provided for pixels arranged in the same row direction (in the lateral direction in FIG. 1). One data line 15 is provided for pixels arranged in the same column direction (in the longitudinal direction in FIG. 1).

A first end of the display element 21 is connected to a power supply Vdd. A second end of the display element 21 is connected to drains of the drive TFT 22a and the drive TFT 22b. Sources of the drive TFT 22a and the drive TFT 22b are connected to a ground power supply Vss.

The signal switch TFT 23a is connected at one of its source and drain to the drive TFT 22a at its gate via a node A. The signal switch TFT 23a is connected at the other of its source and drain to the data line 15, and connected to the scanning line 11 at its gate. The signal switch TFT 23b is connected at one of its source and drain to the drive TFT 22b at its gate via a node B. The signal switch TFT 23b is connected at the other of its source and drain to the data line 15, and connected to the scanning line 12 at its gate.

The reverse bias switch TFT 24a is connected at one of its source and drain to a reverse bias power supply Vrb. The reverse bias switch TFT 24a is connected at the other of its source and drain to the gate of the drive TFT 22a via the node A, connected to the ground power supply Vss via the capacitor 25a, and connected at its gate to the scanning line 12. The reverse bias switch TFT 24b is connected at one of its source and drain to the reverse bias power supply Vrb. The reverse bias switch TFT 24b is connected at the other of its source and drain to the gate of the drive TFT 22b via the node B, connected to the ground power supply Vss via the capacitor 25b, and connected at its gate to the scanning line 11.

Scanning control signals Vscan1 and Vscan2 are sent from the scanning line drive circuit 40 to the scanning lines 11 and 12, respectively. A data control signal Vdata is sent from the data line drive circuit 30 to the data line 15.

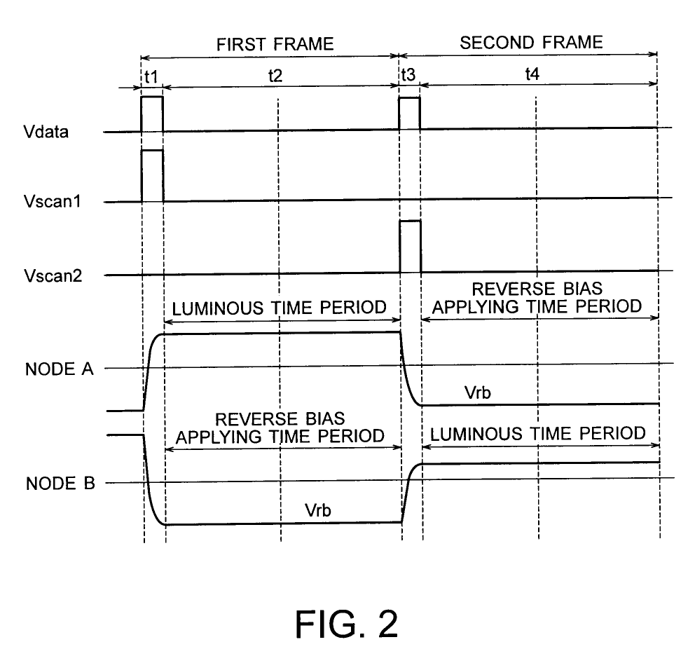

A drive method of the display device according to the present embodiment will now be described with reference to FIG. 2. FIG. 2 is a timing chart showing drive waveforms of the display device according to the present embodiment.

First, in a first frame, the scanning pulse Vscan1 from the scanning line drive circuit 40 is applied to the scanning line 11 and a data pulse Vdata from the data line drive circuit 30 is applied to the data line 15 during a write time period t1. During the write time period t1, the signal switch TFT 23a and the reverse bias switch TFT 24b turn on. Since the signal switch TFT 23a turns on, a potential at the node A rises and a signal voltage is stored across the capacitor 25a. On the other hand, since the signal switch TFT 24b turns on, a potential at the node B falls and a potential at the reverse bias power supply Vrb is stored across the capacitor 25b. In a luminous time period t2 subsequent to the write time period t1, therefore, the drive TFT 22a can supply a drive current to the display element 21 and the display element 21 becomes luminous. On the other hand, in the luminous time period t2, a reverse bias (a voltage which is opposite to the signal voltage in polarity) is applied to the drive TFT 22b and suppression of the threshold voltage shift is conducted.

Subsequently, in a second frame, the scanning pulse Vscan2 from the scanning line drive circuit 40 is applied to the scanning line 12 and a data pulse Vdata from the data line drive circuit 30 is applied to the data line 15 during a write time period t3. During the write time period t3, the reverse bias switch TFT 24a and the signal switch TFT 23b turn on. Since the reverse bias switch TFT 24a turns on, the potential at the node A falls and the potential at the reverse bias power supply Vrb is stored across the capacitor 25a. On the other hand, since the signal switch TFT 23b turns on, the potential at the node B rises and the signal voltage is stored across the capacitor 25b. In a luminous time period t4 subsequent to the write time period t3, therefore, the drive TFT 22b can supply a drive current to the display element 21 and a reverse bias is applied to the drive TFT 22a to suppress the threshold voltage shift.

The threshold voltage shift can be suppressed without causing a fall of the duty factor by conducting the drive in the first frame and the drive in the second frame alternately.

### Second Embodiment

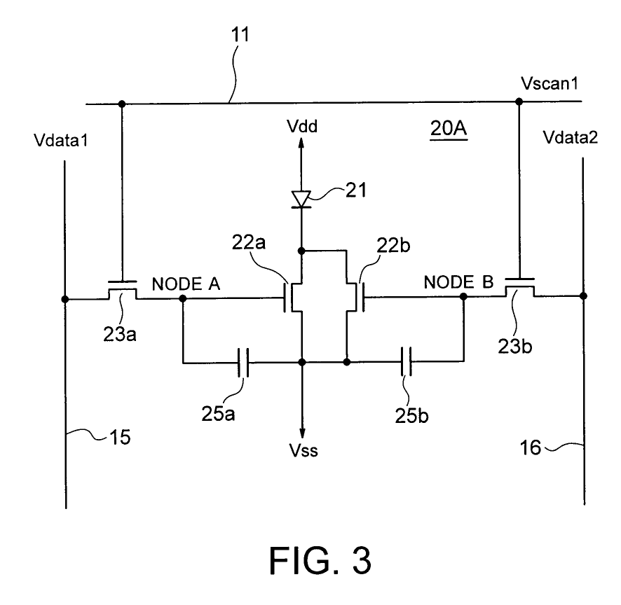

A display device according to a second embodiment of the present invention is shown in FIG. 3. FIG. 3 is an equivalent circuit diagram of one pixel 20A in the display device according to the present embodiment. The display device according to the present embodiment has a configuration obtained by replacing the pixel 20 in the display device according to the first embodiment shown in FIG. 1 with the pixel 20A. The pixel 20A includes a display element 21, two drive TFTs 22a and 22b, two signal switch TFTs 23a and 23b, and two capacitors 25a and 25b. One scanning line 11 is provided for pixels arranged in the same row direction (in the lateral direction in FIG. 3). Two data lines 15 and 16 are provided for pixels arranged in the same column direction (in the longitudinal direction in FIG. 3).

A first end of the display element 21 is connected to a power supply Vdd. A second end of the display element 21 is connected to drains of the drive TFT 22a and the drive TFT 22b. Sources of the drive TFT 22a and the drive TFT 22b are connected to a ground power supply Vss.

The signal switch TFT 23a is connected at one of its source and drain to the drive TFT 22a at its gate via a node A. The signal switch TFT 23a is connected at the other of its source and drain to the data line 15, and connected to the scanning line 11 at its gate. The signal switch TFT 23b is connected at one of its source and drain to the drive TFT 22b at its gate via a node B. The signal switch TFT 23b is connected at the other of its source and drain to the data line 16, and connected to the scanning line 11 at its gate.

The capacitor 25a is connected at its first end to the node A, and connected at its second end to a ground power supply Vss. The capacitor 25b is connected at its first end to the node B, and connected at its second end to the ground power supply Vss.

A scanning control signal Vscan1 is sent from a scanning line drive circuit 40 to the scanning line 11. Data control signals Vdata1 and Vdata2 are sent from a data line drive circuit 30 to the data lines 15 and 16.

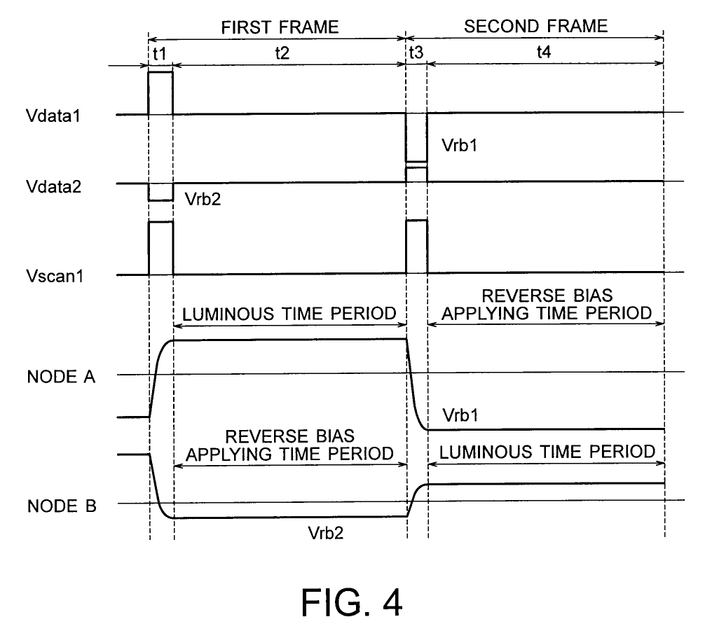

A drive method of the display device according to the present embodiment will now be described with reference to FIG. 4. FIG. 4 is a timing chart showing drive waveforms of the display device according to the present embodiment.

First, in a first frame, signal voltage pulse Vdata1 from the data line drive circuit 30 is applied to the data line 15, a reverse bias Vrb2 is applied to the data line 16, and a scanning pulse Vscan1 is applied to the scanning line 11, during a write time period t1. As a result, both the signal switch TFTs 23a and 23b turn on. Since the signal switch TFT 23a turns on, a potential at the node A rises and a signal voltage is stored across the capacitor 25a. On the other hand, since the signal switch TFT 23b turns on, a potential at the node B falls and a reverse bias Vrb2 is stored across the capacitor 25b. In a luminous time period t2 subsequent to the write time period t1, therefore, the drive TFT 22a supplies a drive current to the display element 21 and a reverse bias continues to be applied to the drive TFT 22b.

Subsequently, in a second frame, the signal voltage Vdata2 is applied to the data line 16, a reverse bias Vrb1 is applied to the data line 15, and the scanning pulse Vscan1 is applied to the scanning line 11, during a write time period t3. As a result, both the signal switch TFTs 23a and 23b turn on. Since the signal switch TFT 23a turns on, the potential at the node A falls and the reverse bias Vrb1 is stored across the capacitor 25a. On the other hand, since the signal switch TFT 23b turns on, the potential at the node B rises and the signal voltage is stored across the capacitor 25b. In a luminous time period t4 subsequent to the write time period t3, therefore, the drive TFT 22b supplies a drive current to the display element 21 and a reverse bias continues to be applied to the drive TFT 22a.

The threshold voltage shift can be suppressed without causing a fall of the duty factor by conducting the drive in the first frame and the drive in the second frame alternately.

In addition, in the second embodiment, the potential of the reverse bias can be specified by using a data line. Therefore, it is possible to apply a different reverse bias potential every scanning line or every frame. In other words, it becomes possible to apply a reverse bias potential suitable for suppression of the threshold voltage shift with due regard to the display history of each pixel.

The embodiments have been described by taking the case where the display element is an OLED as an example. In the present invention, however, the display element is not limited to the OLED. The present invention can be applied to the general display device using a current drive type luminous element having a luminous luminance which changes according to the current value such as a charge injection type inorganic EL element or an electrochemical luminous element.

The embodiments have been descried by taking the case where an n-channel TFT is used as every transistor as an example. However, p-channel TFTs can be used as the drive TFTs by applying a voltage of positive polarity when suppressing the threshold voltage. It is not always necessary to use only n-channel TFTs.

According to the embodiments of the present invention, the threshold voltage shift can be suppressed while keeping the ratio (duty factor) of the luminous time period in one frame high, as heretofore described.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concepts as defined by the appended claims and their equivalents.

What is claimed is:

1. A display device comprising:
a drive circuit which supplies a first signal voltage and a first reverse bias in a first frame time period, and supplies a second signal voltage and a second reverse bias in a second frame time period subsequent to the first frame time period;
a first drive TFT which receives the first signal voltage to supply a first drive current based on the first signal voltage in the first frame time period, and receives the second reverse bias in the second frame time period;
a second drive TFT which receives the first reverse bias in the first frame time period, and receives the second signal voltage to supply a second drive current based on the second signal voltage in the second frame time period; and
a display element which emits light based on the first drive current in the first frame time period and emits light based on the second drive current in the second frame time period.

2. The device according to claim 1, wherein
the display element is connected at one end thereof to a drive power supply, and
each of the first and second drive TFTs is connected at one of a source and a drain thereof to the other end of the display element and connected at the other of the source and the drain thereof to the ground.

3. The device according to claim 2, further comprising in association with the display element:
one data line and first and second scanning lines;
a first signal switch TFT connected at one of a source and a drain thereof to a gate of the first drive TFT, connected at the other of the source and the drain thereof to the data line, and connected at a gate thereof to the first scanning line;
a second signal switch TFT connected at one of a source and a drain thereof to a gate of the second drive TFT, connected at the other of the source and the drain thereof to the data line, and connected at a gate thereof to the second scanning line;
a first reverse bias switch TFT connected at one of a source and a drain thereof to a reverse bias power supply which generates the reverse bias, connected at the other of the source and the drain thereof to a gate of the first drive TFT, and connected at a gate thereof to the first scanning line;
a second reverse bias switch TFT connected at one of a source and a drain thereof to the reverse bias power supply, connected at the other of the source and the drain thereof to a gate of the second drive TFT, and connected at a gate thereof to the first scanning line;
a first capacitor connected at one end thereof to the gate of the first drive TFT and connected at the other end thereof to the ground; and
a second capacitor connected at one end thereof to the gate of the second drive TFT and connected at the other end thereof to the ground,
wherein the data line and the first and second scanning lines are connected to the drive circuit.

4. The device according to claim 2, further comprising in association with the display element:
first and second data lines and one scanning line;
a first signal switch TFT connected at one of a source and a drain thereof to a gate of the first drive TFT, connected at the other of the source and the drain thereof to the first data line, and connected at a gate thereof to the scanning line;
a second signal switch TFT connected at one of a source and a drain thereof to a gate of the second drive TFT, connected at the other of the source and the drain thereof to the second data line, and connected at a gate thereof to the scanning line;
a first capacitor connected at one end thereof to the gate of the first drive TFT and connected at the other end thereof to the ground; and
a second capacitor connected at one end thereof to the gate of the second drive TFT and connected at the other end thereof to the ground,
wherein the first and second data lines and the scanning line are connected to the drive circuit.

5. The device according to claim 4, wherein on each of the first and second data lines, voltage amplitude used when applying the reverse bias is variable.

6. A method for driving a display device including a display element, and first and second drive TFTs which supply a drive current based on a signal voltage to the display element, the method comprising:
in a first frame time period, supplying the drive current to the display element by applying a signal voltage which is based on a drive current to be supplied to the display element, to the first drive TFT and applying a reverse bias to the second drive TFT; and
in a second frame time period subsequent to the first frame time period, supplying a signal voltage which is based on a drive current to be supplied to the display element, to the second drive TFT and applying the reverse bias to the first drive TFT.

7. The method according to claim 6, wherein the reverse bias is variable.
